(19) United States
(12) Patent Application Publication
(10) Pub. No.: US 2007/0103804 A1
(43) Pub. Date: May 10, 2007

(54) Cover glass

(76) Inventor: Thomas W.S. Pang, Toronto, CA (US)

Correspondence Address: Ralph A. Dowell of DOWELL & DOWELL P.C., 2111 Eisenhower Ave, Suite 406, Alexandria, VA, 22314, US

(21) Appl. No.: 11/266,594

(22) Filed: Nov. 4, 2005

(51) Int. Cl. G02B 7/00

(52) U.S. Cl. 359/894; 359/896

(57) ABSTRACT

The present invention is directed to a cover glass comprising a glass substrate having at least one printed image thereon wherein the printed image includes a plurality of clear viewing fields of a predetermined dimension.

### FIELD OF THE INVENTION

This invention relates to an improved cover glass and in particular a cover glass that has a plurality of clear viewing fields.

### BACKGROUND OF THE INVENTION

U.S. Pat. No. 5,766,677 issued to Pang & Dimou, Jun. 16, 1998, described a process to imprint or coat a noble metal or a combination of more than one noble metal, which can adhere to glass, on a cover glass to imprint viewing fields thereon. The cover glass is then used to prepare stable and well-defined viewing fields for counting asbestos and synthetic mineral fibers using phase contrast microscopy (PCM).

Several problems have been discovered with regard to the application of this process. Specifically, the dimensions of the grid openings of the copper electron microscope grids that are used as masks for imprinting viewing fields may vary from 95 microns to 110 microns. Subsequently, the area of each viewing field may vary by 5 to 20%. As well, the viewing fields are arranged such that the user is viewing the sample through the coating. The variation of film coating, which varies from 2.5 to 5.0 nm thick, may affect the fiber images. All the historical asbestos fiber exposure data were obtained from counting fibers by viewing a sample through ordinary coverglasses. Also, the circular viewing field area defined by a special graticule fitted in the eyepiece of the microscope. The viewing field has a diameter of 100 microns. Because of the difference in viewing conditions such as the size of viewing fields and the effects of the noble metal coating on the fiber images, it may be difficult to compare the fiber counts obtained by the prior art method to those historical data.

Accordingly, it would be advantageous to provide a cover glass that will provide stable and well-defined viewing fields that are comparable to historical data.

### SUMMARY OF THE INVENTION

The present invention is directed to a cover glass comprising a glass substrate having at least one printed image thereon wherein the printed image includes a plurality of clear viewing fields of a predetermined dimension.

The object of the present invention to provide a new mask for preparing stable and well defined circular viewing fields for counting asbestos and synthetic mineral fibers using phase contrast microscopy.

Another object of the present invention is that the circular viewing fields do not have a noble metal coating so that the image quality of the fibers is not affected.

Another object of the present invention is that the circular viewing field is the same size as the image projected by the graticule of the eyepiece on to the cleared filter wedge.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a top view of the template of the present invention used to construct the printed images;

FIG. 2 is an enlarged side view of the template of FIG. 1 taken along line 2-2;

FIG. 3 is a perspective view of the template of the present invention on top of a cover glass; and

FIG. 4 is a perspective view of portion of a cover glass having a printed image thereon, the cover glass being constructed in accordance with the present invention.

### DETAILED DESCRIPTION OF THE INVENTION

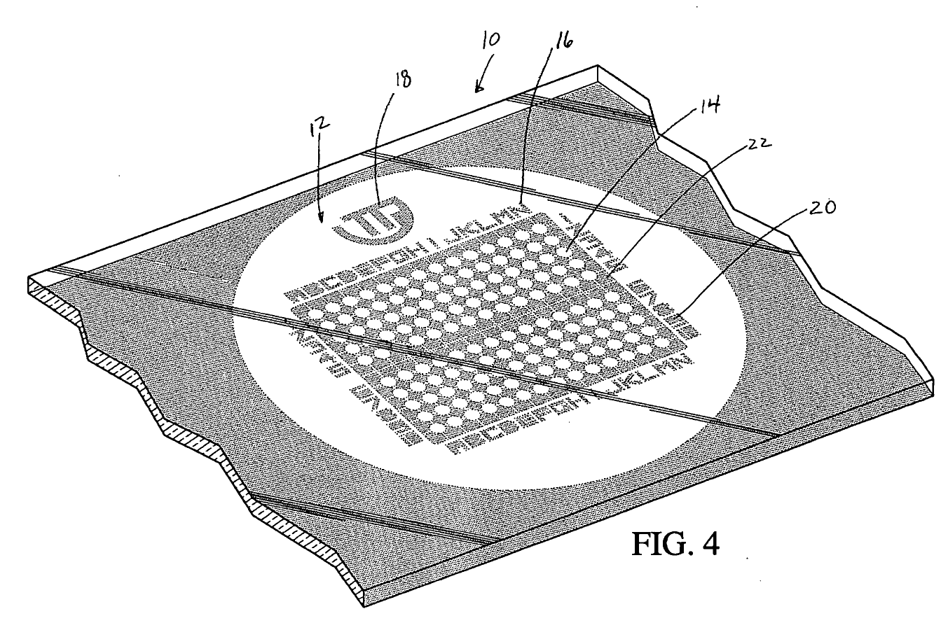

Referring to FIG. 4, a cover glass having a printed images thereon is shown generally at 10.

Preferably each printed image 12 includes fourteen columns of viewing fields 14. Each column of circles is indexed by a letter 16 which appears at the top and the bottom of the column. A mark or logo 18 is placed at the top of the image to denote the top of the image. Each column has ten viewing circles 14, divided into two groups of five. Each row of circles is indexed by a number 20 which appears on the left and the right side of the row. In this way, each viewing circle 14 is uniquely identified by its column and its row. The diameter of each of the circles 14 is 100 micrometers. The distance between each viewing circle 14 is 125 micrometers, measured from center to center. Row 5 and row 6 are separated by larger spacers 22.

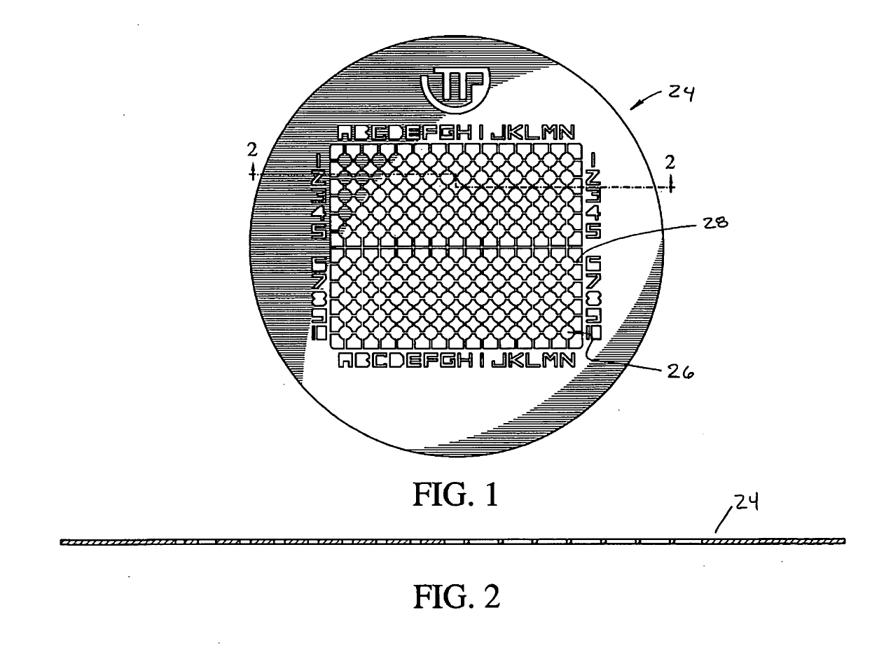

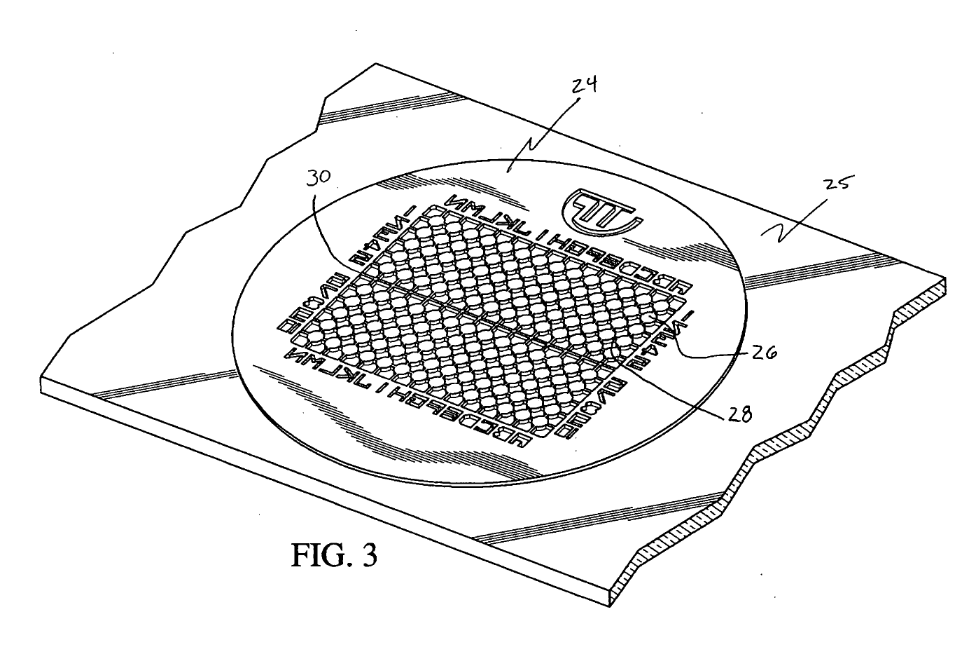

To make a cover glass having a printed image thereon 10 a template or mask 24 as shown in FIGS. 1 to 3 is placed on the cover plate 25. Preferably the circular mask 24 is made of copper with a diameter of 3.05 mm and a thickness of 15 micrometer. However, other metals may also be used such as nickel, gold and platinum. The mask 24 includes a plurality of circles 26 which correspond to the viewing fields 14. The circles 26 are connected to each other and to the mask by means of bars 28. The bars 28 are 20 micro-meter in width. There is a larger space between the fifth and sixth row and a central bar 30.

The cover glass having a printed image thereon 10 may be made in a conventional way. Specifically the cover glass 25 is annealed at 250 degree C. in a muffle furnace. A template for example a gold or copper mask 24 (shown in FIGS. 1 to 3), is placed near the centre of cover glass 25. Preferably, a second grid 24 is then placed adjacent to the first grid such that the openings are more or less parallel with those of the first gird and so that two printed images 12 will be imprinted onto cover glass 25. If desired, more than two grids may be used. Cover glass 25 with the masks 24 placed thereon is placed either in a high-vacuum coating station capable of an atmosphere of 1 times 10 sup-3 to 10 sup-4 Torr, or in a sputter coating station equipped with chemically pure and inert metal target(s).

Cover glass 25 is then coated with an inert nobel metal film which can adhere to glass. Noble metals such as gold, platinum, palladium or a combination thereof may be used. It has been found that gold on its own does not adhere well to the glass and therefore gold on its own would not be used. However, gold in combination with platinum has been found to be effective. Note that, in some instances platinum does not work well on its own because of its high melting point, but this restriction is based on the equipment used to coat the cover glass. A gold/platinum mixture produces an ultra-thin transparent coating with defined viewing fields. The inventors have found that by twisting a gold wire and a platinum wire together, good results are achieved. The film coating is approximately 2.5 to 5.0 nm thick.

In use, a segment about ¼ to ⅕ from a 25 mm diameter mixed cellulose ester (MCE) filter on which asbestos fibres have been previously deposited is cut. The microscope slide is prepared such that filter sample with the fibre deposit side facing upwardly and the imprinted side of the cover glass 10 having printed image 12 imprinted thereon facing downwardly. Thus the fibres to be counted are adjacent to the imprinted viewing fields 14 and effectively the fibres and the viewing fields are in the same depth of focus the microscope. The cover glass 10 is prepared as discussed above. The filter sample is arranged so that it can cover printed image 12 which have been imprinted on the cover glass 10. The slide is then prepared either with an acetone/triacetin clearing method or a dimethyl formamide (DMF)/Euparal clearing method.

Throughout the description of this invention, the term “asbestos” means a product containing one or several types of asbestos fibres such as amosite, chrysotile, crocidolite, anthopylite, tremolite and acetilolite; and the term “synthetic mineral fibre” means a vitreous solid or glass-like fibre whose main element consists of silicon.

It will be appreciated by those skilled in the art that the cover glass of the present invention provides stable and well defined circular viewing fields for counting asbestos and synthetic mineral fibers using phase contrast microscopy. As well, the cover glass of the present invention provides circular viewing fields that do not have a noble metal coating so that the image quality of the fibers is not affected. The cover glass of the present invention provides circular viewing fields that have the same size as the image projected by the graticule of the eyepiece on to the cleared filter wedge. The cover glass of the present invention are used to prepare slides of asbestos containing materials for identification and quantitative determination of the asbestos concentrations. Since the circular viewing fields do not have a noble metal coating, various optical properties of the particles such as refractive index, birefringence color, extinction, pleochroism and signs of elongation etc, can be measured to identify the asbestos particles. By determining the number asbestos particles in a number of viewing fields, one can estimate the concentration of asbestos particles in the sample. Since the viewing fields are uniquely identified and relocatable, the slides can also be used to determine the accuracy and precision of the analyst in identifying asbestos particles in asbestos containing materials.

It will be appreciated by those skilled in the art that the cover glass of the present invention may also be used to prepare slides of microscopic particles, such as the mold spores, for identification and quantitative determination. Since the circular viewing fields do not have a noble metal coating, the image quality of the spores is not affected and they can be identified by their morphology and size. By determining the number spores in a number of viewing fields, one can estimate the concentration of spores in the sample. Since the viewing fields are uniquely identified and relocatable, the slides can also be used to determine the accuracy and precision of the analyst in identifying mold spores.

It will be appreciated that the above description related to one embodiment by way of example only. Many variations on the invention will be obvious to those skilled in the art and such obvious variations are within the scope of the invention as described herein whether or not expressly described.

1. A cover glass for use in association with asbestos fibres comprising:
a glass substrate having at least one printed image thereon wherein the printed image includes a plurality of clear viewing fields of a predetermined dimension and wherein the printed image is made of an inert noble metal adherable to glass.

2. A cover glass as claimed in claim 1 wherein the plurality of viewing fields are arranged in a grid pattern.

3. A cover glass as claimed in claim 2 wherein each view field has a unique identifier associated therewith.

4. A cover glass as claimed in claim 3 wherein the plurality of viewing fields are arranged in a plurality of rows and a plurality of columns.

5. A cover glass as claimed in claim 4 wherein each column is identified with one of a letter and a number and each row is identified as the other of a letter and a number.

6. A cover glass as claimed in claim 5 wherein each viewing field is generally circular.

7. A cover glass as claimed in claim 6 wherein each viewing field has a diameter of approximately 100 microns.

8. A cover glass as claimed in claim 1 wherein the inert noble metal is chosen from a group consisting of platinum, palladium, gold and platinum, and gold and palladium and a combination thereof.

9. A cover glass as claimed in claim 1 wherein each view field has a unique identifier associated therewith.

10. A cover glass as claimed in claim 9 wherein the plurality of viewing fields are arranged in a plurality of rows and a plurality of columns.

11. A cover glass as claimed in claim 10 wherein each column is identified with one of a letter and a number and each row is identified as the other of a letter and a number.
